(19) United States
(12) Patent Application Publication
(10) Pub. No.: US 2018/0082234 A1
(43) Pub. Date: Mar. 22, 2018

(54) INSTRUCTION SYSTEM FOR PREPARING AN ORDER

(71) Applicant: Kitchen Video Technology, LLC, Greenville, MS (US)

(72) Inventors: Jim Hal Burt, Greenville, MS (US); Erdal Yildirim, Sheridan, AR (US); Cem Can, Istanbul (TR)

(21) Appl. No.: 14/875,350

(22) Filed: Oct. 5, 2015

(51) Int. Cl. G06Q 10/06; G06Q 50/12; G06Q 30/06

(52) U.S. Cl. CPC G06Q 10/06316; G06Q 30/0621; G06Q 30/0635; G06Q 50/12

(57) ABSTRACT

The instruction system receives order data identifying the food items to be prepared. The instruction system analyzes the order data to identify the food items and any customizations to the food items. Preparation data, stored either locally or remotely, associates each food item with the components required to prepare the food item. The instruction system determines the food items by reviewing the preparation data to identify the components of the ordered food items. The instruction system then displays an exploded view of the food item showing all of the components associated with the food item with any customizations.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### RESERVATION OF RIGHTS

A portion of the disclosure of this patent document contains material which is subject to intellectual property rights such as but not limited to copyright, trademark, and/or trade dress protection. The owner has no objection to the facsimile reproduction by anyone of the patent document or the patent disclosure as it appears in the Patent and Trademark Office patent files or records but otherwise reserves all rights whatsoever.

### BACKGROUND OF THE INVENTION

### I. Field of the Invention

The present invention relates to an instruction system displaying instructions to prepare an order. The instruction system implements visual cues to instruct the staff the method of preparing a particular item. A display of the present invention shows an exploded image of the item showing the individual components of the item and the order in which the components are arranged. The display presents the information to the staff in a location where the food is prepared. Such an instruction system decreases the amount of training that a restaurant, eatery, caterer, or other food service providers must provide to its employees.

The instruction system communicates with the point of sale system (POS system). A customer orders a particular food item and customizes the food item according to the user's requests. An employee enters the food items requested by the customer into the POS System as an order. The POS system then transfers the order to a Kitchen Video System that displays the order and the food items with customizations associated with the order. The instruction system of the present invention provides detailed instructions to prepare each food item. The instruction system of the present invention decreases preparation time and improves the final product.

A customer demands immediate gratification. The customer may reconsider the purchase if anything prevents the user's immediate gratification. If the consumer is not satisfied, the consumer may go to a competitor who can provide the product immediately. Therefore, businesses desire ways to streamline and quicken the sales process while increasing customer satisfaction.

National restaurants have been a victim of saturation and oversupply. Restaurants survive the competition by maintaining solid profit margins and increasing their customer base. The present invention allows a food service provider to create a visual instruction system that instructs the kitchen staff to prepare an order. The visual instruction system simplifies the preparation process and quickens preparation time.

### II. Description of the Known Art

Patents and patent applications disclosing information relevant to ordering systems are disclosed below. These patents and patent applications are hereby expressly incorporated by reference in their entirety.

U.S. Pat. No. 5,845,263 issued to Camaisa et al. on Dec. 1, 1998 (“the '263 patent”) teaches a portable interactive visual ordering system and method utilizing full-color images. The system taught by the '263 patent may be used by a restaurant to facilitate ordering menu items by a customer. The '263 patent teaches that a customer can request the system to display full-color images of a menu item as a help to decide what to order. The '263 patent also teaches that the customer can also obtain a list of ingredients, method of preparation and nutritional information for a selected menu item. When the customer decides to order a particular menu item, the system taught by the '263 patent captures the ordered item and tabulates a running bill. In another embodiment of the system taught by the '263 patent, multiple visual ordering devices are networked together at the restaurant. An option in the networked system taught by the '263 patent is to allow the customer to pay the bill by a credit card or debit means at his/her table. The system taught by the '263 patent enables businesses to reduce labor costs in running the business and provides the customer with more information at the point of sale to make a more informed decision.

U.S. Pat. No. 5,235,509 issued to Mueller on Aug. 10, 1993 (“the '509 patent”) teaches a method and apparatus for facilitating self-ordering of items, particularly in a fast food environment. The apparatus taught by the '509 patent includes a customer terminal having a display screen that is preferably a touch screen used by the customer during the self-ordering operation. The screen taught by the '509 patent displays information that assists the customer in becoming acquainted with the self-ordering process. The '509 patent teaches that subsequent screens display information relating to the selection of food items. Indicia on the display taught by the '509 patent screen represent food items for selection. The '509 patent teaches that such food items are arranged according to food categories. In accordance with one display taught by the '509 patent, indicia representing primary category food items, such as sandwiches, are shown on the screen. The '509 patent teaches that one or more of such food items can be selected by the customer using the displayed indicia, such as by touching the screen. This same display taught by the '509 patent includes indicia representing a number of menus for secondary food items, such as salads, desserts and drinks. The '509 patent teaches that touching of indicia representing a particular menu causes another display screen to be shown that illustrates predetermined food items associated with that particular menu. The display screen with the primary category food items taught by the '509 patent also preferably includes further indicia. The '509 patent teaches that the selection of such indicia by the customer initiates the occurrence of other predetermined functions, such as cancellation of a previously selected item or an indication that the ordering of food items has been finished. Another screen taught by the '509 patent displays a request as to whether or not the customer wishes to dine in or take out the ordered food items.

Certain problems exist with the aforesaid known art. The known art does not allow the flexibility, instructions, and options provided by the present invention. The present invention provides a simpler solution that enables a food preparer to quickly review the instructions to prepare an order and reduces training required for a company's employees.

Therefore, the present invention is needed to provide a unique instruction system that instructs a food preparer the correct method to prepare a food item.

### SUMMARY OF THE INVENTION

The present invention provides an instruction system displaying instructions of preparing an order. The instruction system implements visual cues to instruct the staff the method of preparing a particular item. A display of the present invention shows a graphical instruction showing the individual components of the item to be prepared and the placement of each component of the item. The display presents the information to the staff in a location where the food is prepared. In one embodiment of the present invention, the instruction system displays an image of an exploded view of the food item. The exploded view shows each component of the food item and the placement of each component in relation to the other components.

The instruction system communicates with the point of sale system (POS system). A customer orders a particular food item that is customizable according to the user's requests. An employee enters the food items requested by the customer into the POS System as an order.

The POS system of one embodiment then transfers the order to a Kitchen Video System (KVS system) that displays the order and the food items with customizations of the order. The KVS system of one embodiment only displays a text listing of each food item of the order. The KVS system also lists any customizations of the food item.

In one embodiment, the POS system also transmits the order of food items with any customizations to the instruction system. The instruction system stores each food item and the components associated with the food item. The instruction system also stores the method of preparing the food item and the placement of the components of the food item. The instruction system of the present invention provides detailed instructions to prepare each food item. The instruction system of one embodiment displays the food items of the order and the placement of the components in the food item.

### Software:

The present invention also utilizes software to enable the instruction system to identify the food items of the order. In one embodiment, the POS system associates each food item with an item identifier. The item identifier is unique to each food item. The POS system also allows a user to customize the food item by adding, removing, and/or substituting components of the food item. The POS system associates each component with a component identifier. The component identifier is unique to each component. The POS system also associates an action, including but not limited to add, remove, and substitute, with an action code to describe the action to be taken with each component.

The Instruction System associates each food item with a food identifier and each component item with a component identifier. The Instruction System also associates the action with the action code. In one embodiment, the Instruction System associates the same identifiers with the same food items, components, actions, etc. as the POS system.

The Instruction System determines the food items that are ordered and any customizations of the food items by reviewing the identifiers. The preparation date of the Instruction System associates each food item with the components of the food item. The Instruction System also stores the method of preparing the food item with the arrangement of the components of the food item. While the POS system identifies the food item, the known POS systems do not identify the components of the food item or the method of preparing the food item.

The Instruction System of the present invention determines the ordered food item by the item identifier. The instruction system also determines the components necessary to construct the food item. The instruction system of one embodiment also associates an image of each component with the component/component identifier. The instruction system then displays an image instructing the user how to prepare the food item with the necessary components.

It is an object of the present invention to provide a visual representation of preparing a food item.

It is another object of the present invention to improve order accuracy.

It is another object of the present invention to provide improved consistency of the ordered item.

It is another object of the present invention to display an image of an exploded view of an item showing the components required to prepare the food item.

It is another object of the present invention to provide a system that communicates with existing systems to avoid modification of existing systems.

It is another object of the present invention to provide a system that can be retrofitted with other systems.

It is another object of the present invention to retrofit existing systems with the instruction system.

It is another object of the present invention to reduce training time.

It is another object of the present invention to improve the final product.

It is another object of the present invention to provide visual cues as to the method of preparing a food item.

It is another object of the present invention to decrease preparation time.

It is another object of the present invention to increase throughput.

It is another object of the present invention to communicate with a business's ordering system to enable the present invention to be installed without affecting the business's ordering system.

It is another object of the present invention to provide a display to show images instruction the preparation of a food item.

These and other objects and advantages of the present invention, along with features of novelty appurtenant thereto, will appear or become apparent by reviewing the following detailed description of the invention.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is an environmental view of one embodiment of the present invention;

FIG. 2 is a schematic view of one embodiment of the present invention;

FIG. 3 is a schematic view of one embodiment of the present invention;

FIG. 4 is a flowchart showing a process of one embodiment of the present invention;

FIG. 5 is a flowchart showing a process of one embodiment of the present invention;

FIG. 6 is a flowchart showing a process of one embodiment of the present invention;

FIG. 7 is a flowchart showing a process of one embodiment of the present invention;

FIG. 8 is a flowchart showing a process of one embodiment of the present invention;

FIG. 9 is a display view of one embodiment of the present invention;

FIG. 10 is a display view of one embodiment of the present invention;

FIG. 11 is a display view of one embodiment of the present invention;

FIG. 12 is a display view of one embodiment of the present invention;

FIG. 13 is a display view of one embodiment of the present invention;

FIG. 14 is a display view of one embodiment of the present invention; and

FIG. 15 shows a display of one embodiment of the present invention.

### DETAILED DESCRIPTION

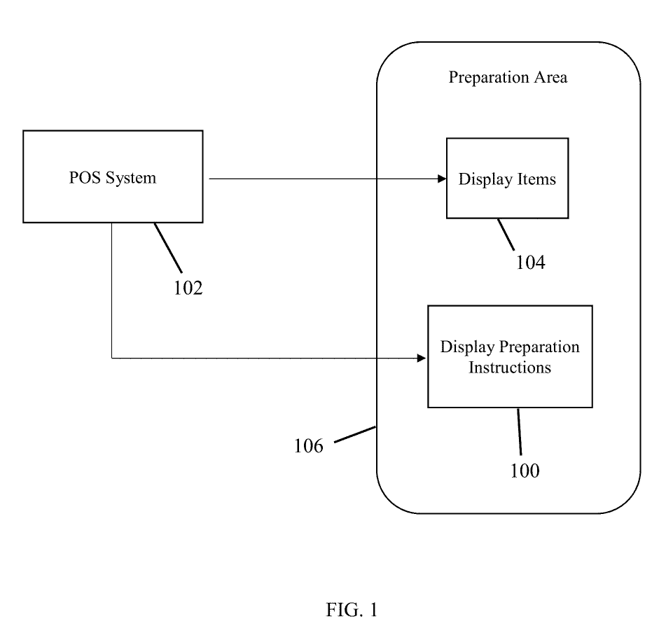

FIG. 1 shows an environmental view of one embodiment of the instruction system 100. The instruction system 100 may be installed at any location. In one embodiment, the instruction system 100 is installed within the preparation area 106 to enable the users, including but not limited to kitchen staff, preparation team, chefs, cooks, or other users, to review the instructions required to prepare an item.

The instruction system 100 provides the user with instructions necessary to prepare a food item. Restaurants require consistency within the manner in which a food item is prepared to maintain the quality the customers expect. The instruction system 100 maintains that consistency. Each food item is constructed of multiple component items. Preparation data defines the component items associated with the food item. The instruction system also defines the placement of each component item within the scheme of the food item. Maintaining the consistency of the placement of the components on the food items provides for a consistent taste and quality.

The instruction system 100 provides a display that shows the visual instructions as to the placement of each component of the food item. The system 100 receives an order of at least one food item. The instruction system 100 identifies the components of the food item of the order and displays the components in the appropriate order.

In operation, an order is entered into the Point of Sale System 102 (POS). The POS system transmits the order to the preparation area 106. The users, such as the kitchen staff, preparation team, chefs, cooks, or other users, working in the preparation area 106 can view a display of the items at Display Items 104 and the instructions at Display Preparation Instructions 100. In one embodiment, the Display Items 104 shows a text description of the food items of an order with any customizations. The Display Preparation Instructions 100 shows an image of the food items of an order with the proper placement of each component of the food items.

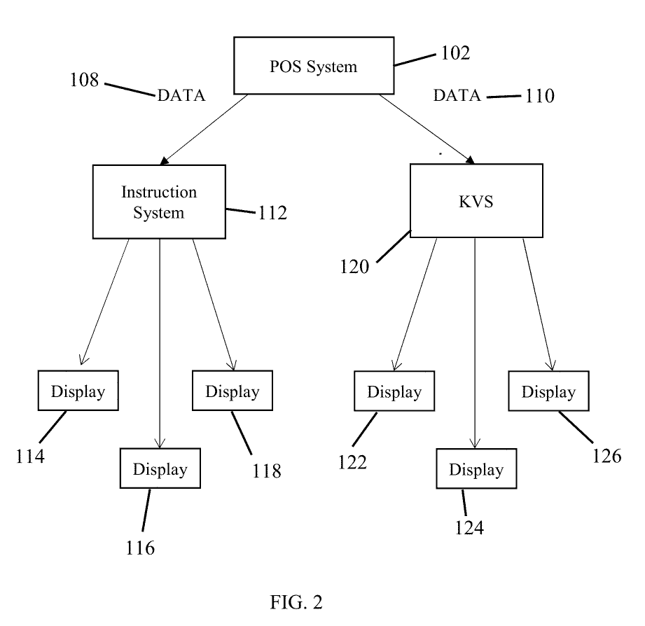

FIG. 2 shows a POS System 102 into which a user enters the order. A customer requests an order of food items. The user enters the order into the POS system 102. After the user completes the order, the POS system 102 transmits the order data 108, 110 to the Instruction System 112 and the Kitchen Video System 120 (KVS). Data 108, 110 includes the different food items associated with the order. Each order data 108, 110 provides all of the different food items and the customizations associated with the order.

The KVS 120 receives data 110 from the POS system 102. The KVS 120 interprets the data 110 and displays order text identifying the food items ordered with any customizations. The text descriptions are displayed within the preparation area on Displays 122, 124, 126. These displays 122, 124, 126 may be located throughout the restaurant, eatery, preparation station, etc. The displays 122, 124, 126 may be dispersed in separate locations such as a kitchen, drink station, a preparation area, dessert station, and/or drive through window.

The instruction system 112 receives data 108 from the POS system 102. The instruction system 112 interprets data 108 and displays a graphical depiction of the food items and the arrangement of the components of the food items. The Instruction system 112 displays the graphical depiction of the food items on displays 114, 116, 118. Similar to the KVS 120, displays 114, 116, 118 may be located throughout the restaurant, eatery, preparation station, etc. The displays 114, 116, 118 may be dispersed in separate locations such as a kitchen, drink station, a preparation area, dessert station, and/or drive through window. In one embodiment, displays 114, 116, 118 show an image of an exploded view of the ordered food item(s) with customizations.

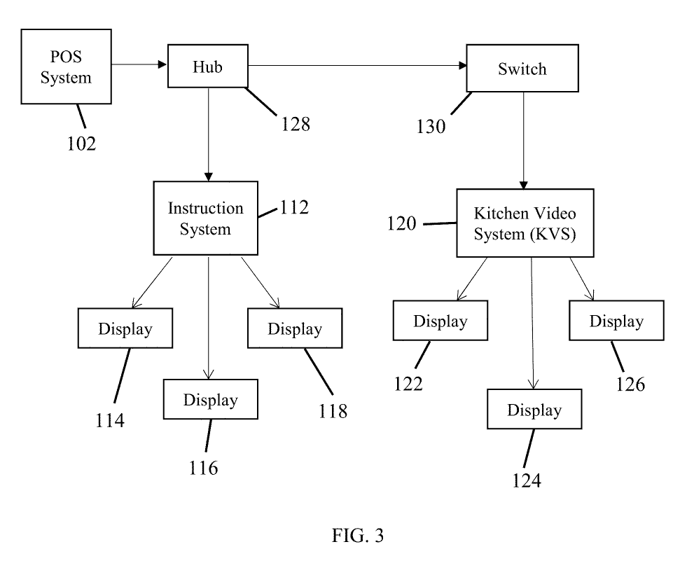

FIG. 3 shows an environmental view of the POS system 102, Instruction system 112, and KVS 120. The POS system 102 communicates with hub 128 which allows the transfer of order data from the POS system 102 to the instruction system 112 and KVS 120. Hub 128 transfers the data to the instruction system 112 and switch 130. The instruction system then displays the graphical depiction on displays 114, 116, 118.

The hub 128 transmits order data to switch 130 which then transmits the order data to KVS 120. The KVS 120 then displays the order text on displays 122, 124, 126. The hub 128 and switch 130 enables the POS system 102 and the KVS 120 to be retrofitted with the instruction system 112. Retrofitting with the instruction system 112 enables the system 112 to be installed without modifying the POS system 102 or the KVS 120. The additional devices are installed into the system to avoid manipulating the existing systems and configurations.

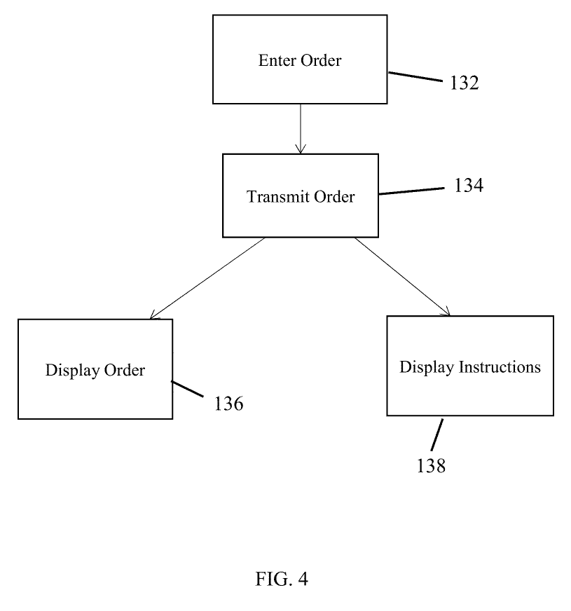

FIG. 4 shows the process of creating an order and transferring the order to the proper system for display to the users. A user enters an order for at least one food item at Enter Order Step 132. The food items may include, but are not limited to, hamburgers, sandwiches, wraps, chicken nuggets, chicken fingers, chicken, fish, salads, breakfast items, yogurt, parfait, bagels, pancakes, bacon, sausage, biscuits, hash browns, oatmeal, tacos, side items, French fries, onion rings, fruit, beverages, milk, juice, soft drinks, water, bottled water, iced tea, brewed beverages, coffee, latte, mocha, hot chocolate, iced coffee, iced mocha, frappe, smoothie, lemonade, frozen lemonade, strawberry lemonade, milk shakes, café drinks, desserts, ice cream, sundaes, pie, cookies, and blended ice cream. Each of the food items is prepared from at least one or more components. These components are arranged in a particular order. For other food items, the components may be placed into the food item in a particular order to create the food item. The preparation data stores the association of the food items and the components required to prepare the food items. The preparation data also stores information identifying the location and manner in which component is applied in the food item.

The user enters the order of food items into a computer system, such as a POS system that creates an order. The user enters the order at Enter Order 132. The user may add additional components, remove components, substitute components, or otherwise modify the food item. The user will enter such modifications while entering the order at Enter Order 132. The system will provide an action code with a component identifier. The action code indicates such actions as add a component, remove a component, or substitute a component, increase the amount of a component, and/or reduce the amount of a component. The action code may include other actions for the food item.

The computer system, such as the POS system, transmits order data identifying the ordered food items and any customizations, including but not limited to the action codes with the component identifiers. The computer system transmits the order data at Transmit Order 134 to the KVS and the Instruction System.

The KVS system then accesses the order data and displays the order to the users at Display Order 136. KVS displays text identifying the food items of the order and the customization of the food items. The KVS displays the name of the food item and a text description of the customization, such as “add pickles,” “remove mayonnaise,” and/or “substitute sesame bun.”

The instruction system accesses the order data and displays the graphical instructions to the users at Display Instructions 138. FIG. 4 shows one embodiment in which the POS system and KVS system is retrofitted with the instruction system. Such retrofit usage of the KVS system avoids interfering with existing configurations to reduce installation downtime.

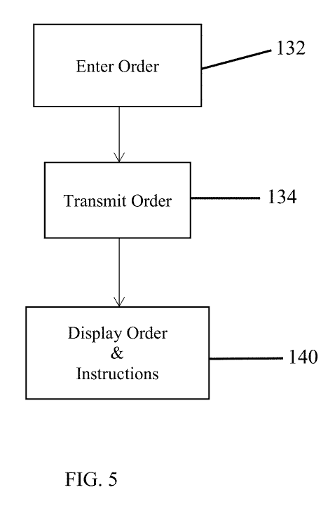

FIG. 5 shows another embodiment in which the instruction system functions with the KVS system. In this embodiment, the system implements the KVS system and the instruction system into a single system. The POS system transmits the order data and the customizations to the instruction system which then displays the image of the food items of the order. In such an embodiment, the system does not require retrofitting. Therefore, fewer devices are required for implementing the instruction system as the instruction system functions within the existing device configuration.

As discussed above, a user enters the order at Enter Order 132. The order includes food items and the customizations as discussed above. The user enters the order into a computer system such as a POS system. The POS system transfers the order data to the preparation area or other location where the users can view the orders and the instructions at Transmit Order 134. The instruction system then displays the text of the order with customizations and the images of the exploded view of the item with components at Display Order & Instruction 140.

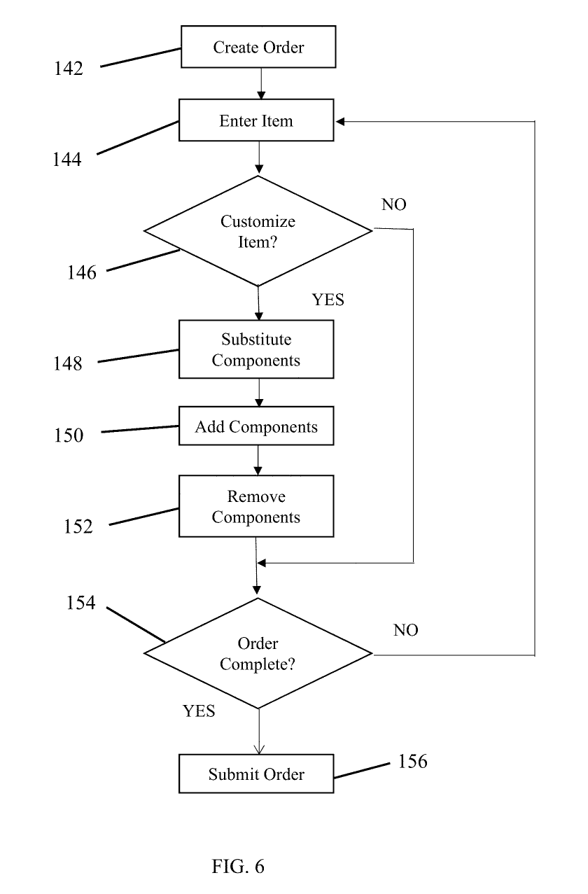

FIG. 6 shows the process of creating an order in the computer system such as the POS system. The order may be entered into a POS system or other computer system at Create Order 142. The user enters the ordered food items into the computer system at Enter Item 144. The item may be prepared normally or it may be customized. If the item is not to be customized, the user enters the food item and then enters any additional food items for the order. If no more food items are to be added, the user completes the order at Order Complete 154 and the system submits the order at Submit Order 156.

The user is not required to accept the food item as normally prepared. The user may customize each food item by adding components, removing components, substituting components, increasing an amount of a component, and/or reducing the amount of a component. The user selects an action code, such as add, remove, or substitute a component, and selects the component to be added, removed, or substituted.

The customization process will now be described in greater detail. Each order can be customized. For example, a user may substitute a food item of a combo meal with other food items. For example, a user may substitute fruit, chips, or other substitution for French fries. If a portion of the combo meal is to be substituted, the user selects a substitute entry and selects the item to be substituted. In such an embodiment, the system provides multiple food items with the order data to identify all of the food items associated with a combo meal in an order.

The user may also substitute components of a food item at Substitute Components 148. The user may substitute special sauce with mustard or substitute grilled chicken with fried chicken. The user may also substitute the type of bun for a hamburger or sandwich. Other substitutions of components may occur. The user selects the substitute entry and selects the component to substitute. The computer system then adds the food item with the substituted components to the order data. The order data identifies the food item and the substituted components through the use of identifiers. The order data includes the item identifier, the action code for substituting a component, and the component identifier identifying the component to be substituted. The order data associates the action code with the substituted component identifier to inform the users that the selected component is to be substituted.

The user may also add components of a food item at Add Components 150. The user may add bacon, mustard, special sauce, grilled onions, etc. to a food item. The user may also add extra chocolate or ice cream to desserts. Other additions of components may occur. The user selects the add entry and selects the components to add. The computer system then adds the food item with the added components to the order data. The order data identifies the food item and the added components through the use of identifiers. The order data includes the item identifier, the action code for adding a component, and the component identifier identifying the component to be added. The order data associates the action code with the added component identifier to inform the users that the selected component is to be added to the food item. The instruction system identifies the placement of the added component in relation to the other components.

The user may also remove components of a food item at Remove Components 152. The user may remove pickles, mayonnaise, onions, etc. from a food item. The user may remove other components if necessary. The user selects the remove entry and selects the components to remove. The computer system then adds the food item with the removed components to the order data. The order data identifies the food item and the removed components through the use of identifiers. The order data includes the item identifier, the action code for removing a component, and the component identifier identifying the component to be removed. The order data associates the action code with the removed component identifier to inform the users that the selected component is to be removed from the food item. The instruction system identifies the components of each food item. The instruction system emphasizes that the particular component is to be removed from the food item.

The computer system creates order data that identifies the ordered food items with the customizations. The order data of one embodiment includes an order identifier that identifies the particular order. The order identifier allows the user to provide the customer with the appropriate order.

The order data includes all of the food items associated with the order. The food items of one embodiment are identified by a unique food item identifier. The unique item identifier enables the KVS system and the instruction system to identify the food item and inform users of the food item to be prepared and the manner in which the food item is to be prepared.

The order data also includes customization information regarding the manner in which the food item is to be customized. The order data provides an action code, including but not limited to add, remove, or substitute. The order data also includes the component identifier that informs the user which action (adding, removing, substituting, increasing, or decreasing) should be taken with regards to the component. The KVS system provides a text description of the food item with the action code and component. The instruction system provides an image of all components of the food item and emphasizes the modifications as to how the food item is traditionally prepared.

Once the order is complete at Step 154, the computer system submits the order data to the instruction system at Submit Order 156. Transmitting the order data from the computer system or POS system enables the KVS system and the instruction system to receive the order data. The order data may be sent to the instruction system only, the KVS system only, or both the KVS and the instruction system.

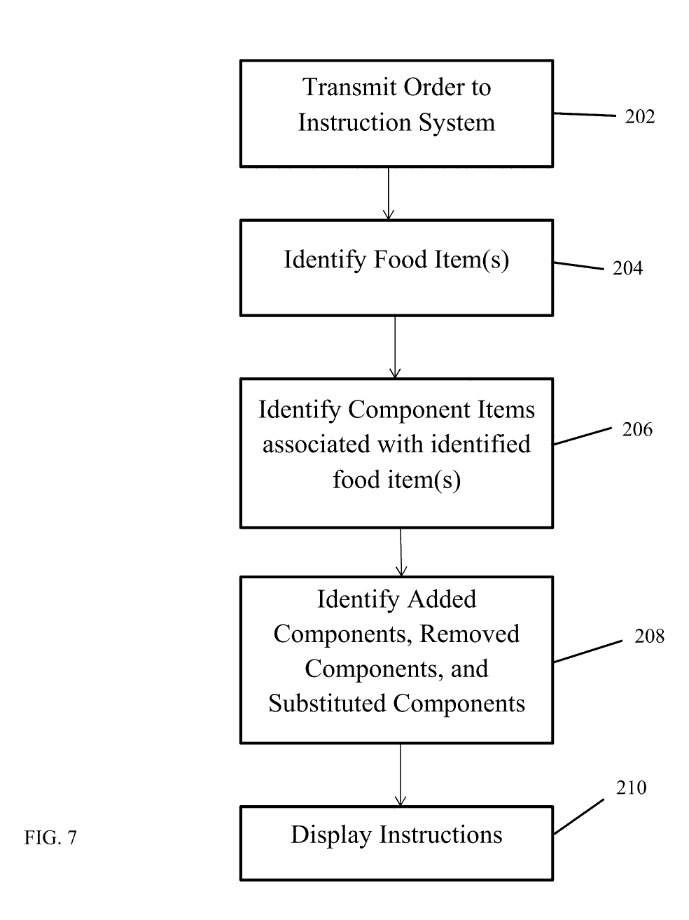

FIG. 7 shows the process of displaying the instructions of one embodiment of the present invention. The order data is transmitted to the instruction system at Transmit Order 202. The order data, including but not limited to the identification of the food items and the customizations of the food items, is transmitted to the instruction system. In one embodiment, the POS system transmits the identifiers of the food items of the order and the customizations which include any action codes and the component identifiers of the customizations. In one embodiment, the POS system transmits the order data to the instruction system. In another embodiment, a computer system transmits the order data to the instruction system.

The instruction system receives the order data and identifies the food item(s) of the order at Identify Food Item(s) 204. In one embodiment, the identifiers associated with the food items, the component items, and the actions are stored locally within the system. In another embodiment, the identifiers are stored remotely. The identifiers may be stored in a database or other accessible storage system that allows the instruction system to identify the food items and components associated with the order.

In one embodiment, the system accesses identifiers associated with the different food items and components. Examples of identifiers are listed below.

| ITEM IDENTIFIER | ITEM NAME |
|---|---|
| 1 | Hamburger |
| 2 | Double Hamburger |
| 3 | Cheeseburger |
| 4 | Double Hamburger |
| 10 | Rib Sandwich |
| 148 | Cheese |
| 913 | Grilled Onions |
| 1043 | Bacon |
| 6647 | Regular Bun |
| 6648 | Sesame Bun |
| 1000 | Special Bun |
| 1002 | Hamburger Patty |
| 1004 | Pickles |
| 1006 | Lettuce |
| 1008 | Onion Flakes |
| 1010 | Special Sauce |
| 1012 | Ketchup |
| 1014 | Mustard |
| 1100 | Chicken Fingers |
| 1102 | Milk Shake |
| 1104 | Chocolate |
| 1106 | Ice Cream |
| 1108 | Regular Cone |
| 1110 | Waffle Cone |

The examples above include food items such as hamburgers, cheeseburgers, chicken fingers, milk shakes, ice cream, etc. The examples above also include components such as cheese, grilled onions, bacon, bun types, hamburger patties, pickles, lettuce, onion flakes, special sauce, ketchup mustard, cone types, etc.

The instruction system associates each food item with the components required to prepare the food item. The instruction system identifies the order and arrangement of the components required to prepare the food item at Identify Component Items 206. Identifying the arrangement of the components instructs the user the method of preparing the food item. The instruction system provides a graphical depiction of the food item with an exploded view of the food item showing the placement of the components as shown in FIGS. 10, 12, and 14.

The instruction system receives the order data that includes the food item identifier and any customizations. The customizations include action codes and a component identifier. The instruction receives the food item identifier and determines which food item is to be prepared. The instruction system determines the components of the ordered food items by looking up the food item in a database or other storage. Such storage could be remote or local.

The instruction system also determines the components of the food items at Identify Component Items 206. All of the components of a food item are stored either locally or remotely in preparation data. Preparation data may be a database, a table, or other organized collection of data. The preparation data associates each food item with the components required to prepare the food item. The instruction system accesses an image of each component to display the component images of the components associated with the food item and the customizations.

For example, the preparation data associates a hamburger, an example of one food item, with the components of a top bun, onions, lettuce, pickle, ketchup, mustard, hamburger patty, and bottom bun. The instruction system receives an order for a food item for a hamburger. The KVS system may only show that a hamburger was ordered. The instruction system accesses the preparation data to identify the method of preparing the hamburger and the components to prepare the hamburger.

The instruction system provides a graphical depiction of the hamburger showing the arrangement of all of the components of the hamburger. The instruction system accesses the preparation data to identify each component. The instruction system also accesses storage to retrieve images of each component of the food item or customized food item. The instruction system shows a picture of each component, the top bun, onions, lettuce, pickle, ketchup, mustard, hamburger patty, and bottom bun. Each component, the top bun, onions, lettuce, pickle, ketchup, mustard, hamburger patty, and bottom bun, is associated with a component identifier and a component picture.

As stated above, the instruction system also allows customization of each food item. The instruction system accesses the action codes of the order data and the components associated with each action code at Identify Customizations 208. At Identify Customizations 208, the instruction system identifies the added components, the removed components, and the substituted components. The instruction system then displays the instructions at Display Instructions 210. The instructions include an image of the food item with all of the components. The instruction system identifies the added components, the removed components, and the substituted components. Such additions, removals, and the substitutions are displayed at Display Instructions 210.

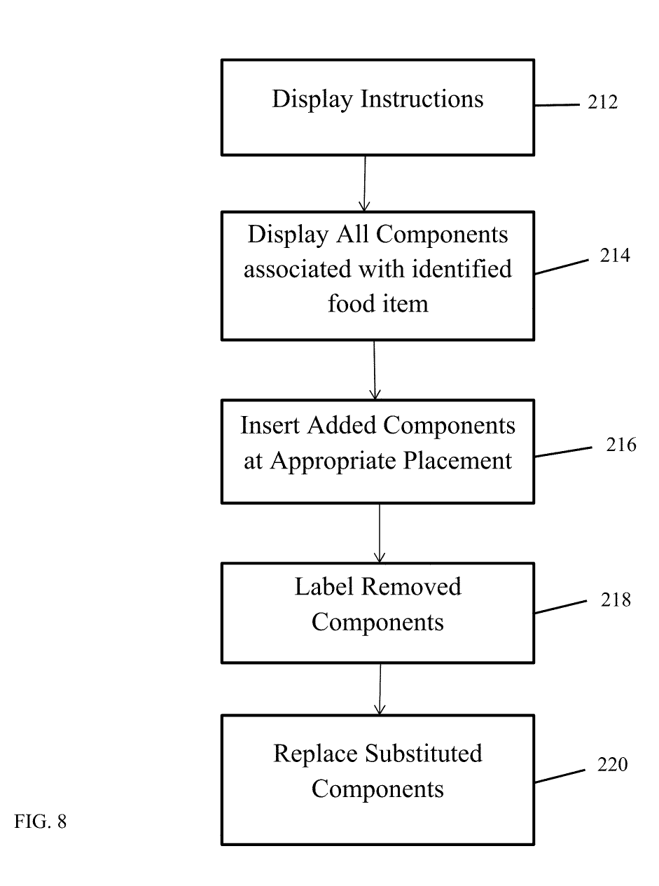

FIG. 8 shows the process of displaying the instructions at Display Instructions 212. The instruction system accesses the preparation data to identify the components required to prepare the food item. The instruction system of one embodiment displays an exploded view of the food item showing an image resembling each component of the food item. In one embodiment, each component of the food item is associated with an image file showing the component. These component images are displayed with proper placement of each component image needed to prepare the food item.

When displaying the instructions, the system displays the component images of the components required to prepare a food item at Display All Components 214. The instruction system accesses the components required to prepare the food item, the arrangement of the components, and the component images. The instruction system displays the component images of the components associated with the food item. In one embodiment, the instruction system shows the components required to prepare the food item without customization (the default components). In another embodiment, the instruction system only shows the components of the customized food item such that removed components are not shown.

The instruction system must also display the components to be added to the food item. The instruction system identifies the action code and the associated component. The instruction displays the image of the added component in the appropriate location at which the component is to be placed at Insert Added Components 216. The instruction system displays the placement of the added component in relation to the components of the food item as normally prepared without customization, the default components. The instruction system of one embodiment emphasizes the added component by highlighting the added component or adding text emphasizing that the component has been added.

The instruction system of one embodiment also shows the removed components at Label Removed Components 218. The instruction system receives the action code to delete a component. The instruction system emphasizes that the component is to be removed from the default components. The instruction system marks the components to be removed with a removal indicator, such as an X over the components to be removed. The instruction may also place text indicating that the component should be removed from the food item. In another embodiment, the instruction system does not display the removed components with the food item.

The instruction system also replaces substituted components at Replace Substituted Components 220. The instruction system receives the action code to substitute a component. The instruction system displays the food item with the substitute component. The system highlights the changes or provides text emphasizing that the component should be substituted. In another embodiment, the instruction system simply displays the components of the food item with the substitute component replacing the default component.

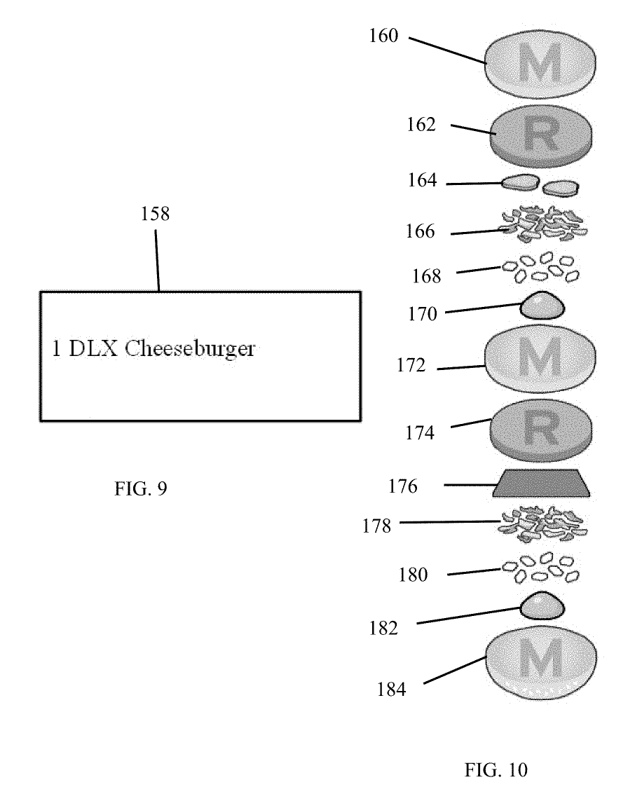

FIGS. 9-13 show examples of the KVS system and the instruction system displaying the order of a food item, such as a cheeseburger. FIGS. 9, 11, and 13 show the KVS display. FIGS. 10, 12, and 14 show the display of the instruction system.

FIGS. 9 and 10 show the default preparation of a cheeseburger. The KVS system shown in FIG. 9 displays text showing the food items of an order 158. The order includes 1 cheeseburger without any customization. The users prepare the cheeseburger according to the default method without any customization.

FIG. 10 provides the graphic depiction of preparing the cheeseburger. The image shows the default components of the food item, the cheeseburger. The default components include top bun 160, beef patty 162, pickles 164, lettuce 166, onion flakes 168, special sauce 170, middle bun 172, beef patty 174, cheese 176, lettuce 178, onion flakes 180, special sauce 182, and bottom bun 184. In this example, the instruction system receives food item identifier 3 to indicate a cheeseburger. The instruction does not receive any action codes as the default cheeseburger is to be prepared without customizations.

The food item identifier 3 is associated with the components shown in FIG. 10. For example, the preparation data associates food item identifier 3 with components: sesame bun 6648, hamburger patty 1002, pickles 1004, lettuce 1006, onion flakes 1008, special sauce 1010, sesame bun 6648, hamburger patty 1002, cheese 148, onion flakes 1008, special sauce 1010, and sesame bun 6648. The preparation data provides the order in which the components are to be arranged when preparing the designated food item. The instruction system displays an exploded view of the food item with an image of each component in the proper arrangement.

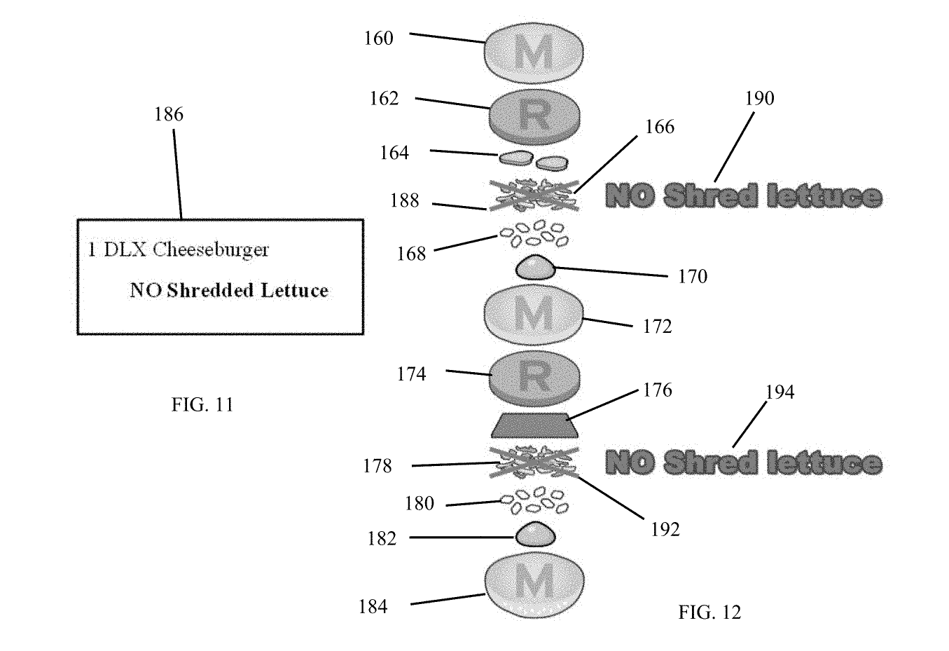

FIGS. 11 and 12 show a customized cheeseburger without shredded lettuce. The user enters the order into the POS system or other computer system requesting removal of shredded lettuce from the food item. The POS system transmits order data including the food item identifier 3 with the remove action code associated with lettuce 1006 to the KVS and instruction system.

The KVS system and the instruction system receive the action code indicating removal of shredded lettuce from the cheeseburger. Order 186 of the KVS system shows the order of one cheeseburger with no shredded lettuce.

The instruction system also receives the remove action code associated with shredded lettuce. Therefore, the instruction system displays the food item, the cheeseburger, with removing the shredded lettuce.

The image shows the default components of the food item, the cheeseburger. The default components include top bun 160, beef patty 162, pickles 164, lettuce 166, onion flakes 168, special sauce 170, middle bun 172, beef patty 174, cheese 176, lettuce 178, onion flakes 180, special sauce 182, and bottom bun 184. In this example, the instruction system receives food item identifier 3 to indicate a cheeseburger. The instruction system receives the remove action code associated with the shredded lettuce.

The preparation data associates food item identifier 3 with the components 6648, 1002, 1004, 1006, 1008, 1010, 6648, 1002, 148, 1008, 1010, 6648 as described above. The preparation data provides the order in which the components are to be arranged when preparing the designated food item. The instruction system displays an exploded view of the food item with an image of each component in the proper arrangement.

The instruction system received the action code indicating removal of the shredded lettuce. The instruction system emphasizes that lettuce should be removed. In one embodiment, the instruction system places a removal indicator 188, such as an X or red X, across the components to be removed. The instruction system also displays removal indicator 190 showing text emphasizing the removal of a particular component. The removal indicators 188, 190 inform users that the order includes a customized item in which particular components have been removed.

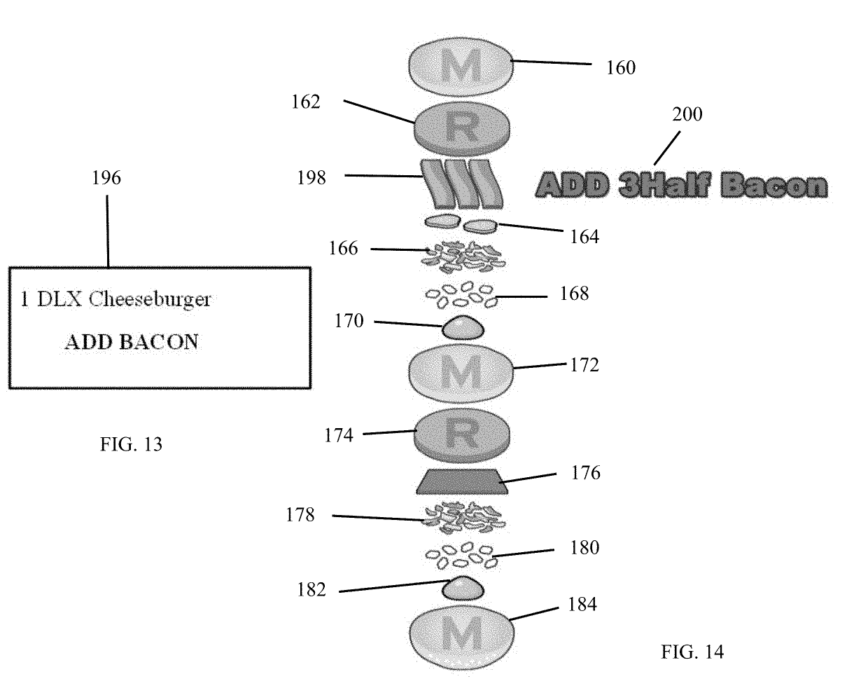

FIGS. 13 and 14 show a customized cheeseburger with added bacon. The user enters the order into the POS system or other computer system requesting addition of bacon to the food item. The POS system transmits order data including the food item identifier 3 with the add action code associated with bacon 1043 to the KVS and instruction system.

The KVS system and the instruction system receive the action code indicating addition of bacon to the cheeseburger. Order 196 of the KVS system shows the order of one cheeseburger with added bacon.

The instruction system also receives the add action code associated with bacon. Therefore, the instruction system displays the food item, the cheeseburger, with added bacon.

The image shows the default components of the food item, the cheeseburger. The default components include top bun 160, beef patty 162, pickles 164, lettuce 166, onion flakes 168, special sauce 170, middle bun 172, beef patty 174, cheese 176, lettuce 178, onion flakes 180, special sauce 182, and bottom bun 184. In this example, the instruction system receives food item identifier 3 to indicate a cheeseburger. The instruction system receives the add action code associated with the bacon.

The preparation data associates food item identifier 3 with the components 6648, 1002, 1004, 1006, 1008, 1010, 6648, 1002, 148, 1008, 1010, 6648 as described above. The preparation data provides the order in which the components are to be arranged when preparing the designated food item. The instruction system displays an exploded view of the food item with an image of each component in the proper arrangement.

The instruction system received the action code indicating addition of bacon to the food item. The instruction system emphasizes that bacon should be added. In one embodiment, the instruction system places add indicator 200 on or near the added component to emphasize addition of component 198, the bacon. The add indicator may include text to indicate the addition of the component. The add indicator may also highlight or otherwise emphasize that the component is to be added.

While a cheeseburger has been described above, the instruction system operates with other food items, drinks, desserts, sandwiches, tacos, etc. The preparation data is customizable to allow instructions for preparing a variety of items. The component images may include images of a variety of components required to prepare the different items. The images may include photographs, drawings, etc. to properly identify the component.

In one embodiment, the instruction system may not display the components required to prepare a food item if a single component is required to prepare the food item. For example, an order of chicken nuggets may not include additional components. Therefore, the user simply needs to count the number of chicken nuggets for an order. In such an embodiment, the instruction system may not display the instructions for preparing the chicken nuggets in the instruction system.

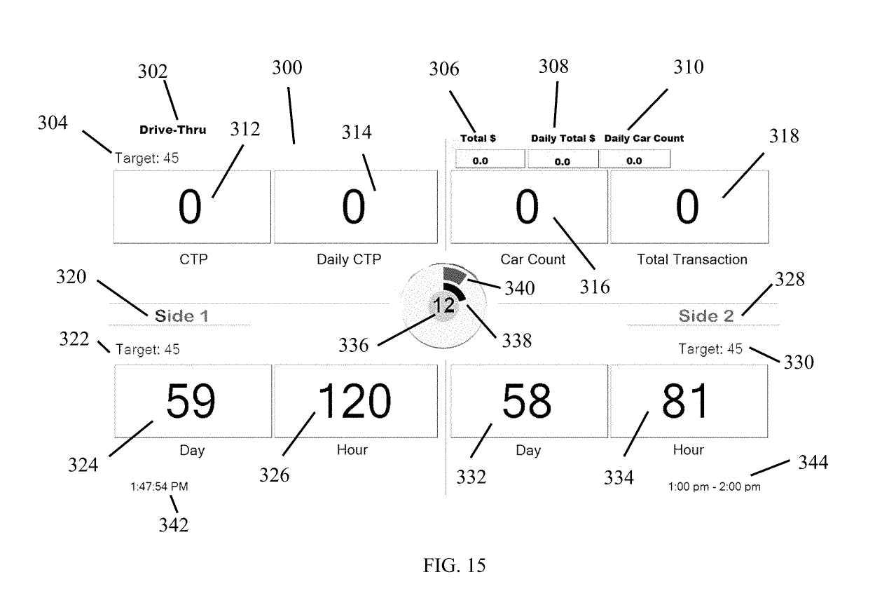

FIG. 15 shows a status system 300 of the restaurant displaying real time point of sale information. The status system 300 motivates the users to work quicker and more efficiently. The status system 300 displays goals to the users encouraging the users to meet and beat the displayed goals. The status system 300 also informs management of how efficiently and quickly the users and employees are working. The system 300 also informs users if they are not meeting their goals or if they are not working quickly and efficiently.

In one embodiment, the restaurant may provide two preparation areas, side 320 and side 328. The restaurant tracks the performance of sides 320, 328 to determine the efficiency of the preparation areas and the restaurant. The status system 300 may monitor counter service, a particular counter, a particular station, or a drive thru window. One embodiment of the present invention provides the status of the Drive-Thru 302.

The system 300 also compares the current statistics to the target goals. In one embodiment, the system 300 displays the current statistics differently depending on whether the users are meeting the desired target goals. If users are meeting the target goals, the system displays the current statistics in a first color, such as green. If the users are not meeting the target goals, the system displays the current statistics in a second color, such as red.

The status system 300 monitors the order and delivery area of the restaurant to determine the total amount of money received by the restaurant for a given time period, such as an hour (total dollars 306) and the total daily amount of money received by the restaurant (daily total dollars 308). The system may also monitor the total amount of money spent during a given time period, such as an hourly amount or a meal time amount such as breakfast, lunch, or dinner.

Because some users may not require access to the sales data, such as total dollars 306 and daily total dollars 308, the system 300 may not display such sales data. In such an embodiment, the administrator may choose to not display such sales data by system 300. The system will then display the remaining statistics, including but not limited to CTP, Daily CTP, Car count, total transactions, daily car count and the daily and hourly preparation times for the sides.

The system also tracks the number of orders made during the day. In one embodiment for the drive-thru, the system tracks the daily car count 310. The system counts the number of cars that cross a sensor in the drive-thru. In another embodiment, the system may count the number of orders made at a register, such as the drive-thru register. The car count and/or order count provides the users with order information as to the number of people served and the efficiency of progressing to the next order.

The system 300 tracks the time efficiency of the users by identifying the time required to present an order, referred to as cash to present (CTP). The user enters a customer's order into the point of sale system. The customer must then pay for the order. The user renders payment to a user of the system. The CTP timer starts when the user renders payment. The system stops the CTP timer after the order is presented to the customer. The user enters input into the system indicating that the order has been presented. Such input may be entered by pressing a button or push bar. The CTP timer stops after the user enters the input indicating that the order has been presented.

The system 300 tracks the average time required to present the order after payment has been rendered, CTP. CTP time is measured in seconds in certain types of restaurants, such as fast food restaurants. Other restaurants may measure CTP time in minutes. CTP 312 identifies the average CTP time for the current time period 344, such as the current hour. Daily CTP 314 displays the average CTP time for the day. CTP 312 and Daily CTP 314 show the average times for the particular ordering area, such as the drive-thru.

The user can quickly compare the daily CTP 314 and hourly CTP 312 to the target time 304. Target time 304 identifies the target CTP time for the designated area, such as the drive-thru. The manager designates the target time 304 as a goal for the users to meet. The users can compare CTP 312 and Daily CTP 314 to the target 304 to confirm that the users are meeting the target. If the users are meeting the target, CTP 312 and Daily CTP 314 will be displayed in a first color indicating that the CTP goals are met. The system 300 displays CTP 312 in a second color, such as red, if the users are not meeting the target for the current time period, such as the current hour. The system 300 displays CTP 314 in a second color, such as red, if the users are not meeting the target for the day.

In the drive-thru environment, some drive-thru areas provide two windows, a first window for receiving payment and a second window for presenting food. In such an environment, the CTP and daily CTP measure the average time spent waiting from rendering payment at the first window to receiving the ordered items at the second window.

System 300 also maintains information regarding the number of cars that pass through the drive-thru during a given time period, such as an hour, at car count 316. Car count 316 informs the users of the number of cars that have passed through the drive-thru during the current time period.

Total transaction 318 identifies the number of transactions occurring throughout the restaurant during the current time period. Total transaction 318 includes the transactions occurring through the drive thru and the counter service. Such information provides the user with the number of customers who are ordering at the restaurant. Car count 316 and total transaction 318 informs the users of the user traffic. The user can determine if the restaurant is experiencing high customer activity or low customer activity. A comparison of car count 316 and total transaction 318 also informs the user of whether people are ordering their food and drinks inside at the counter or outside through the drive thru.

As discussed above, the restaurant may track two different preparation areas, such as side 320 and side 328. The POS system informs the preparation team of the ordered items and the items to be prepared. In one embodiment, the KVS system informs the users of the ordered items. The system measures the time required to prepare the ordered items referred to as the preparation time. The preparation timer starts after the KVS system displays the order to the users. After the users complete the order, the users enter input into the system that the order has been completed. The users may enter the input via a button or bump bar that signals the system 300 that the order is complete. The preparation timer stops after the user inputs that the order is complete.

The system 300 maintains the average daily preparation time 324 and the average hourly preparation time 326 for side 320. The system 300 also maintains the average daily preparation time 332 and the average hourly preparation time 334 for side 328.

The user can quickly compare the daily preparation time 324 and hourly preparation time 326 to the target time 322 of side 320. Target time 322 identifies the target preparation time for side 320. The manager designates the target time 322 as a goal for the users of side 320 to meet. The users can compare daily preparation time 324 and hourly preparation time 326 to the target 322 to confirm that the users are meeting the target. If the users are meeting the target, daily preparation time 324 and hourly preparation time 326 will be displayed in a first color, such as green, indicating that the preparation goals are met. The system 300 displays daily preparation time 324 in a second color, such as red, if the users are not meeting the target for the current time period, such as the current hour. The system 300 displays hourly preparation time 326 in a second color, such as red, if the users are not meeting the target for the day.

A similar comparison can be made for side 328. The user can quickly compare the daily preparation time 332 and hourly preparation time 334 to the target time 330 of side 328. Target time 330 identifies the target preparation time for side 328. The manager designates the target time 330 as a goal for the users of side 328 to meet. The users can compare daily preparation time 332 and hourly preparation time 334 to the target 330 to confirm that the users are meeting the target. If the users are meeting the target, daily preparation time 332 and hourly preparation time 334 will be displayed in a first color, such as green, indicating that the preparation goals are met. The system 300 displays daily preparation time 332 in a second color, such as red, if the users are not meeting the target for the current time period, such as the current hour. The system 300 displays hourly preparation time 334 in a second color, such as red, if the users are not meeting the target for the day.

The system 300 also provides the time information for the information currently displayed. The system provides time 342 identifying the time. The system also provides current time period 344, such as the hour time period. FIG. 15 shows the information for the hour of 1:00 to 2:00 pm. In one embodiment, the system 300 operates using the average over an hourly basis.

The system 300 provides a clock showing the time left for the current time period 344. Time 342 shows that 12 minutes and 6 seconds remain in the current time period. Minutes 336 displays the number of minutes remaining in the current time period 344. Minutes countdown 338 informs the user of the percentage of minutes remaining in the current time period. Seconds countdown 340 shows the percentage of seconds remaining for the current minute.

The display of system 300 may be a monitor that is located at a designated location in the restaurant, such as above the drink machines. The display is located where the appropriate users can view the display. In one embodiment, the display is positioned such that customers cannot view the display. In another embodiment, the display may be located in an area only visible to a manager, such as an office, etc.

An administrator, such as a manager, may set the target goals of the system 300 such as target times 304, 322, 330. The manager may establish the target goals of the same time last year, a target goal based on a previous time period, the target goals based on another restaurants activity, fully customized target goals, etc. The manager may share the information with other restaurants to establish target goals. The managers may also share their information to create a competition between the different restaurants.

With the use of the timers and display, the system can also maintain the freshness of particular components. Certain components of a food item can be placed within the preparation area for a limited amount of time. The components must then be discarded after the time period has expired. The system associates a discard time period with each component that requires disposal after a discard time period. The user enters a start time input indicating that the component has been placed within the preparation area. The system searches the component to determine if a discard time period is associated with the component. The system starts a discard timer associated with the component that counts down the time before the component must be discarded. Once the discard timer reaches zero, an alarm or other indicator activates informing the user to discard the component. An image, text, or audio identifying the component may be associated with the discard time and the alarm or other indicator to inform the user which component to discard. The alarm or other container continues until the user indicates that the component has been discarded

From the foregoing, it will be seen that the present invention is one well adapted to obtain all the ends and objects herein set forth, together with other advantages which are inherent to the structure.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the accompanying drawings is to be interpreted as illustrative and not in a limiting sense.

What is claimed is:

1. A system for providing instruction to prepare a food item, the system implemented on a computing device, the system comprising:
a sales system that accepts an ordered item of at least one food item;
the ordered item comprising at least one component;
an instruction system that receives order data item from the sales system wherein the order data identifies the ordered item;
the instruction system identifying the components of the ordered item;
the instruction system displaying the components of the ordered item.

2. The system of claim 1 further comprising:
the instruction system displaying images of the components of the ordered item.

3. The system of claim 2 further comprising:
the instruction system displaying an exploded view of the ordered item and the components of the ordered item.

4. The system of claim 1 further comprising:
the instruction system associating the food item with at least two components required to prepare the food item.

5. The system of claim 4 further comprising:
the instruction system accessing preparation data associating the food item with the components required to prepare the food item.

6. The system of claim 5 further comprising:
the preparation data defining an instruction that identifies the arrangement of the components required to prepare the food item.

7. The system of claim 1 further comprising:
an action code indicating to add a component to the food item to create the ordered item.

8. The system of claim 1 further comprising:
an action code indicating to remove a component from the food item to create the ordered item.

9. The system of claim 1 further comprising:
an action code indicating to substitute a component from the food item.

10. The system of claim 6 further wherein the instruction system displays the components according to the arrangement of the components defined by the instruction.

11. A system for providing instruction to prepare a food item, the system implemented on a computing device, the system comprising:
a point of sales system that accepts an ordered item of at least one food item;
the ordered item comprising at least one component;
an instruction system that receives order data from the point of sale system, wherein the order data identifies the ordered item;
the instruction system identifying the ordered item;
the instruction system accessing preparation data to identify at least two components required to prepare the food item;
the preparation data identifying at least two components associated with the food item;
the instruction system displaying component images of the components of the food item.

12. The system of claim 11 wherein the instruction system displays an exploded view of the food item displaying the component images.

13. The system of claim 12 wherein the component images are arranged in the order required to prepare the food item.

14. The system of claim 13 wherein the preparation data defines instructions identifying the components required for default preparation of the food item wherein the default preparation of the food item defines preparing the food item without customization of the food item.

15. The system of claim 14 wherein the instruction system displays the components required for default preparation of the food item according to the instructions.

16. The system of claim 15 further comprising:
wherein the ordered item is a customization of the food item that includes an added component to be added to the food item to prepare the ordered item;
an action code indicating the added component;
the instruction system displaying the component images for default preparation of the food item;
the instruction system displaying a component image of the added component at a location at which the added component is to be added in relation to the other components.

17. The system of claim 16 further comprising:
the instruction system displaying an add indicator on or near the added component.

18. The system of claim 15 further comprising:
wherein the ordered item is a customization of the food item wherein the ordered item requires removal of a removed component to prepare the ordered item;
an action code indicating a removed component to be removed from the food item to prepare the ordered item;
the instruction system displaying the component images for default preparation of the food item;
the instruction system displaying a removal indicator on or near the removed component.

19. A system for providing information to a user regarding ordering a food item in a drive-thru, the system implemented on a computing device, the system comprising:
a timer for identifying the amount of time required to complete a task;
a display showing a target time indicating that the user should complete the task within the target time;
the computing device calculating an average time required to complete the task within a current time period;
the computing device displaying an average time required to complete the task over a day wherein the current time period is different than a day;
the computing device maintaining a car count indicating the number of cars using the drive-thru; and
the display showing the car count.

20. The system of claim 19, wherein the computing device displays the average time in a first color if the user meets the target time;
The computing device displays the average time in a second color if the user does not meet the target time wherein the first color and the second color are not the same.
